(19) United States
(12) Patent Application Publication
(10) Pub. No.: US 2014/0300558 A1
(43) Pub. Date: Oct. 9, 2014

(54) ELECTRONIC APPARATUS, METHOD OF CONTROLLING ELECTRONIC APPARATUS, AND PROGRAM FOR CONTROLLING ELECTRONIC APPARATUS

(71) Applicant: Kabushiki Kaisha Toshiba, Tokyo (JP)

(72) Inventor: Ryuichi Yamaguchi, Ome-shi (JP)

(73) Assignee: KABUSHIKI KAISHA TOSHIBA, Tokyo (JP)

(21) Appl. No.: 14/149,642

(22) Filed: Jan. 7, 2014

(30) Foreign Application Priority Data
Apr. 5, 2013 (JP) 2013-079892

(51) Int. Cl. G06F 3/041

(52) U.S. Cl. CPC G06F 3/0416
USPC 345/173

(57) ABSTRACT

According to one embodiment, an electronic apparatus includes: an input module formed in a touch panel in which a touch input and a pen input by a handwriting pen are performed on; a hold designation module in which a hand that is to hold the handwriting pen is designated; a pen point portion detector configured to detect a position of a pen point portion of the handwriting input pen with respect to the input module; and a controller configured to control a part of the input module at a position opposed to a holding portion of the handwriting pen so as not to detect the touch input in accordance with the detected position of the pen point portion and the designated hand that is to hold the handwriting input pen.

### CROSS REFERENCE TO RELATED APPLICATION(S)

The application is based upon and claims the benefit of priority from Japanese Patent Application No. 2013-079892 filed on Apr. 5, 2013, the entire contents of which are incorporated herein by reference.

### BACKGROUND

1. Field

The present invention relates to an electronic apparatus, a method of controlling an electronic apparatus, and a program for controlling an electronic apparatus.

2. Description of the Related Art

Recently, electronic apparatuses in which a touch panel (input module) functioning also as a display screen is used, and a touch input such as a multi-touch operation, a pen input by a handwriting pen, or the like is enabled, such as a tablet PC and a smart phone are widely used.

Among such electronic apparatuses, there are those in which both a touch input and a handwriting pen input are possible.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a view showing the appearance of an electronic apparatus of an embodiment;

FIG. 2 is a view showing an example of the configuration of an input module (touch panel) of the electronic apparatus of the embodiment;

FIG. 3 is a view showing an example of the configuration of a handwriting pen which can perform a handwriting input on the electronic apparatus of the embodiment;

FIGS. 4A to 4C are views showing an example of a display screen on which, in the electronic apparatus of the embodiment, the user designates the direction of the electronic apparatus in the case where a handwriting pen input is performed, and the hand that is to hold the handwriting pen;

FIGS. 5A to 5C are views showing another example of the display screen on which, in the electronic apparatus of the embodiment, the user designates the direction of the electronic apparatus in the case where a handwriting pen input is performed, and the hand that is to hold the handwriting pen;

FIG. 6 is a diagram showing a manner in which, in the electronic apparatus of the embodiment, the handwriting pen that can perform a handwriting pen input detects the inclination in “Write” mode, and the electronic apparatus disposes a touch operation non-detector in a detector (touch panel) in accordance with the detected inclination of the pen;

FIG. 7 is a diagram showing a manner in which, in the electronic apparatus of the embodiment, the handwriting pen that can perform a handwriting pen input detects the inclination in “Erasure” mode, and the electronic apparatus disposes the touch operation non-detector in the detector (touch panel) in accordance with the detected inclination of the pen;

FIG. 8 is a block diagram showing an example of the configuration of the electronic apparatus of the embodiment;

FIGS. 9A to 9C are views showing a manner in which, in the electronic apparatus of the embodiment, the handwriting pen that can perform a handwriting pen input detects the inclination in “Write” mode, and the electronic apparatus disposes the touch operation non-detector in the detector (touch panel) in accordance with the detected inclination of the pen;

FIG. 10 is a flowchart illustrating the operation of “Write” mode in the electronic apparatus of the embodiment; and

FIG. 11 is a flowchart illustrating the operation of “Erasure” mode in the electronic apparatus of the embodiment.

### DETAILED DESCRIPTION

According to one embodiment, an electronic apparatus includes: an input module formed in a touch panel in which a touch input and a pen input by a handwriting pen are performed on; a hold designation module in which a hand that is to hold the handwriting pen is designated; a pen point portion detector configured to detect a position of a pen point portion of the handwriting input pen with respect to the input module; and a controller configured to control a part of the input module at a position opposed to a holding portion of the handwriting pen so as not to detect the touch input in accordance with the detected position of the pen point portion and the designated hand that is to hold the handwriting input pen.

Hereinafter, an embodiment will be described with reference to the drawings.

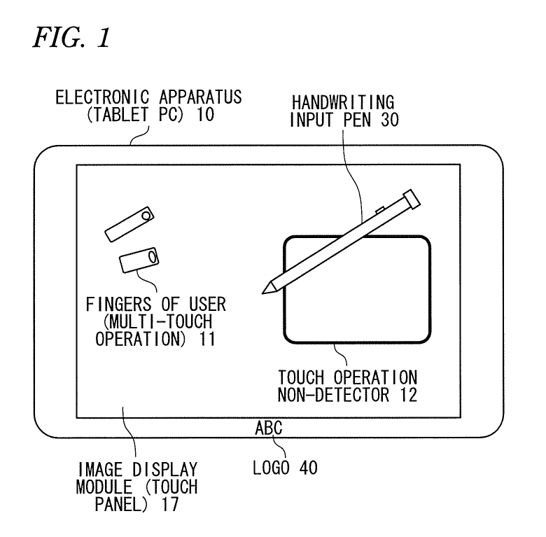

FIG. 1 is a view showing the appearance of an electronic apparatus of the embodiment.

In the embodiment, the electronic apparatus (tablet PC) 10 includes a touch panel 17 constituting a detector functioning also as an image display module.

The electronic apparatus (tablet PC) 10 can simultaneously perform a touch input and a pen input by a handwriting input pen on an input module formed in the touch panel 17.

For example, the user places the electronic apparatus (tablet PC) 10 in a horizontal manner so that a logo 40 of “ABC” is disposed in the front side, and can touch the touch panel 17 with the fingers 11 to perform a touch input (multi-touch operation).

Simultaneously, the user can touch the touch panel 17 with a handwriting input pen 30 to perform a pen input by the handwriting pen 30.

At this time, a part of the input module (touch panel 17) at a position opposed to a holding portion 32 of the handwriting input pen 30 is controlled by a CPU 101 or the like so that a touch operation non-detector 12 where the touch input is not detected is disposed. This will be described later.

Although the description will be made by using a tablet PC as an example of the electronic apparatus 10, the electronic apparatus 10 of the embodiment is not limited to a tablet PC, and may be applied to another electronic apparatus such as a smart phone or a television receiver.

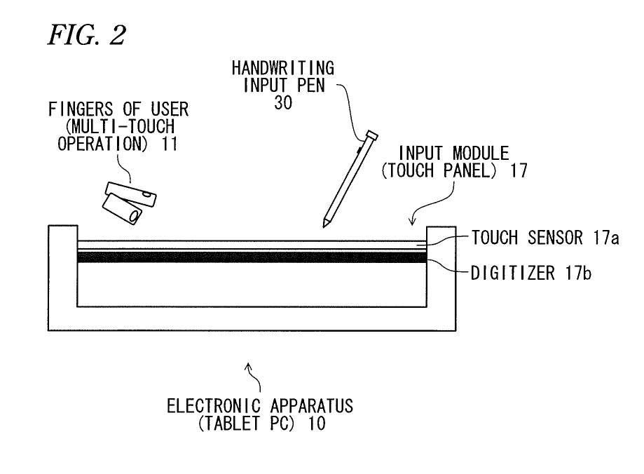

FIG. 2 is a view showing an example of the configuration of the input module (touch panel) of the electronic apparatus of the embodiment.

In the embodiment, the input module (touch panel) 17 includes a touch sensor 17a which detects a touch input by the user, and a digitizer 17b which can detect the position of the pen point portion 31 of the handwriting input pen 30 and the like, and an input operation performed by the input pen 30.

Here, the touch sensor 17a is configured by, for example, a capacitive touch panel.

For example, capacitive touch panels are classified into a surface type and a projection type. In the both types of touch panels, a change of the electrostatic capacitance between the fingertip of the user and a conductive film is captured, and the position is detected.

Moreover, the characteristic that capacitive coupling occurs simply when the finger approaches the surface of the sensor (touch sensor 17a) is utilized so that also a display or operation in which a cursor is displayed before a touch of the finger is enabled.

In a surface capacitive touch panel, usually, three layers, i.e., a cover, a conductive film, and a glass substrate are configured, the conductive film is applied to the glass substrate, and electrodes are disposed in the four corners of the glass substrate, respectively. A uniform electric field is formed by the conductive film.

When the finger of the user touches the display screen, a weak current of a driving circuit flows through the terminal of a corner, the conductive film, and the cover to constitute a closed circuit between the ambient environment including the ground and the driving circuit. The rates of the current amounts of the four corners are measured on the side of the driving circuit, thereby enabling the position of the finger of the user to be detected.

A projection capacitive touch panel can perform multipoint detection of fingertips. Usually, a projection type is configured by an insulation film, an electrode layer formed therebelow, and a substrate layer on which a control IC is mounted.

In the electrode layer below the insulation film, many mosaic-like electrode patterns which consist of as two vertical and horizontal layers, and each of which is formed by a transparent electrode made of ITO (Indium Tin Oxide) or the like are placed on the substrate made of glass or plastics.

When the finger of the user touches the touch panel, changes of electrostatic capacitances of electrodes in the vicinity of the touched portion are known from the two vertical and horizontal electrode rows, thereby allowing the position to be accurately detected. The multipoint detection is enabled by the many electrode rows which extend vertically and horizontally.

The digitizer 17b detects an input operation performed with using an electronic pen (handwriting input pen 30) by means of, for example, electromagnetic induction.

In the electromagnetic induction technology, for example, a sensor section is placed below a liquid crystal screen to constitute a pen-input touch panel.

In the embodiment, the touch panel 17 configures the capacitive touch sensor 17a and the electromagnetic induction type digitizer 17b.

According to the configuration, the touch panel can be operated by the input pen 30 or the fingertip 11 of the user. When the electronic pen (input pen 30) is used, it is possible to detect the pen pressure, a side switch, and the like.

According to this system, without sacrificing the visibility of the capacitive touch sensor, an accurate electromagnetic induction pen can be used on the capacitive touch sensor (touch sensor 17a) in which an input by a pen (input pen 30) is usually disabled.

In the case where the user wishes to perform a pen input with using the handwriting input pen 30, when the hand (not shown) which holds the pen 30 is placed on the touch panel 17, for example, the electronic apparatus 10 may detect the hand placed on the touch panel 17 as a touch input. The embodiment solves this problem (this will be described later).

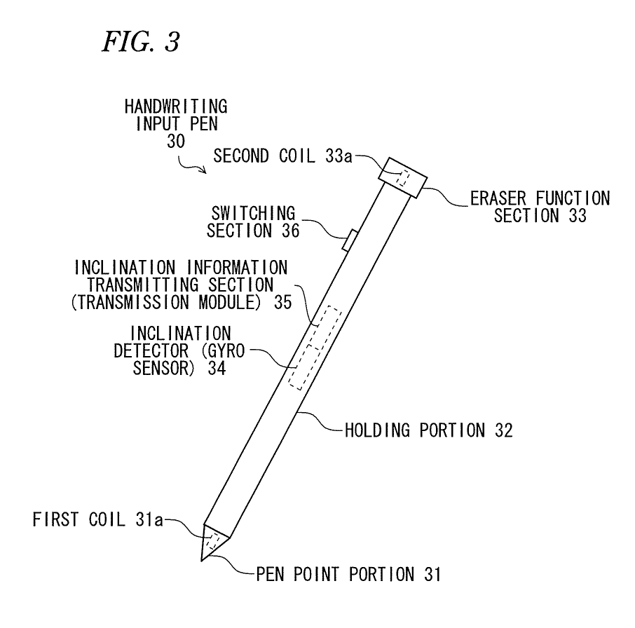

FIG. 3 is a view showing an example of the configuration of a handwriting pen which can perform a handwriting input on the electronic apparatus of the embodiment.

The handwriting input pen 30 is held by the right or left hand of the user, and then a pen input is performed on the touch panel 17.

As shown in FIG. 3, the handwriting input pen 30 in the embodiment includes a holding portion 32 that is a portion to be held by the user, and a pen point portion 31 that is a portion through which a pen input is to be performed on the touch panel 17, and which corresponds to a so-called pen point. For example, the pen point portion 31 is used in “Write” mode in which a handwriting input is performed.

Here, the pen point portion 31 substantially incorporates an electromagnetic coil (first coil 31a). During an inputting operation (“Write” mode) on the electronic apparatus 10, for example, the digitizer 17b generates a magnetic field, and, when the electromagnetic coil (first coil 31a) disposed in the point (pen point portion 31) of the handwriting input pen 30 approaches the digitizer 17b, a change is caused in the magnetic field according to the principle of electromagnetic induction. The change is detected to detect the position of the handwriting input pen 30.

In the embodiment, the handwriting input pen 30 includes an eraser function section 33 at a position opposite to the pen point portion 31 across the holding portion 32. For example, the eraser function section 33 is used in “Erasure” mode in which an inputting operation is performed by a handwriting input.

Here, the eraser function section 33 substantially incorporates an electromagnetic coil (second coil 33a). During an inputting operation (“Erasure” mode) on the electronic apparatus 10, for example, the digitizer 17b generates a magnetic field, and, when the electromagnetic coil (second coil 33a) disposed in the head (eraser function section 33) of the handwriting input pen 30 approaches the digitizer 17b, a change is caused in the magnetic field according to the principle of electromagnetic induction. The change is detected to detect the position of the handwriting input pen 30.

A switching section 36 is a switch for, for example, switching over “Write” mode and “Erasure” mode in which an inputting operation is performed by a handwriting input.

When the user operates the switching section 36, “Write” mode and “Erasure” mode in which an inputting operation is performed by a handwriting input are switched over.

For example, the holding portion 32 includes an inclination detector 34 which can detect the inclination (inclination information) of the handwriting input pen 30, and an inclination information transmitting section 35 which can transmit the inclination information of the handwriting input pen 30 that is detected by the inclination detector 34, to the electronic apparatus 10.

For example, the inclination detector 34 includes a gyro sensor, and the inclination information transmitting section 35 includes a transmission module.

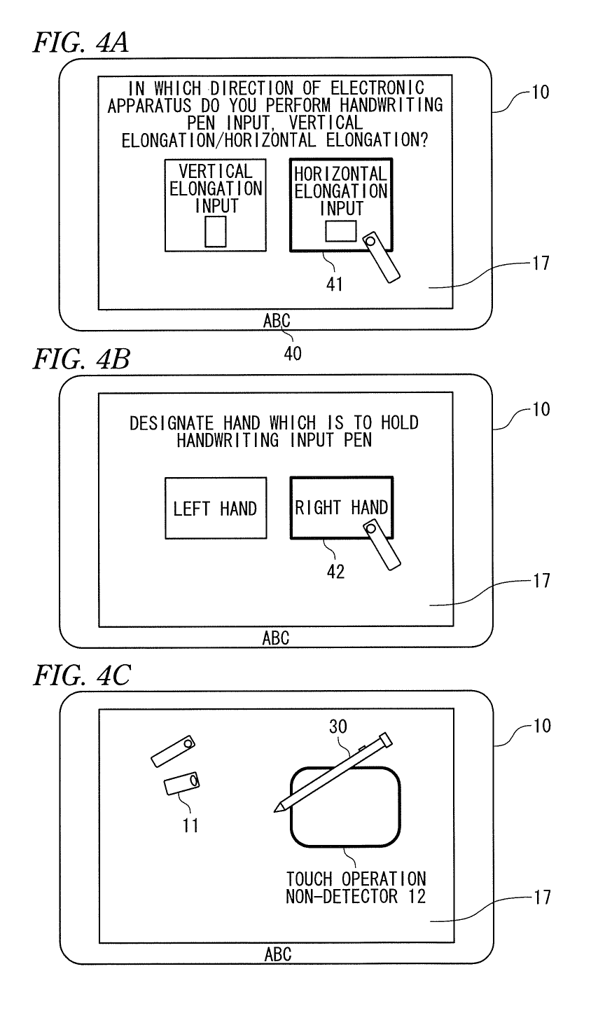

FIGS. 4A to 4C are views showing an example of a display screen on which, in the electronic apparatus of the embodiment, the user designates the direction of the electronic apparatus in the case where a handwriting pen input is performed, and the hand that is to hold the handwriting pen.

As shown in FIGS. 4A to 4C, an example of a display screen is shown on which, in a state where the electronic apparatus 10 is placed so as to be horizontally elongated with respect to the user, the user can designate the direction of the electronic apparatus in the case where a handwriting pen input is performed.

FIG. 4A shows an example of a display screen for designating the direction of the electronic apparatus 10 in which a handwriting pen input is performed.

Here, “In which direction of electronic apparatus do you perform handwriting pen input, vertical elongation/horizontal elongation?” is displayed on the image display module 17 functioning also as a touch panel so that the user can designate the direction of the electronic apparatus 10 in which a handwriting pen input is performed, for example, either of the vertically elongated direction or the horizontally elongated direction.

Here, “Horizontal elongation” 41 is designated as the direction of the electronic apparatus 10 in which a handwriting pen input is performed, by the finger 11 of the user.

FIG. 4B shows an example of a display screen for designating the hand by which the user is to hold a handwriting input pen.

Here, “Designate hand which is to hold handwriting input pen” is displayed on the image display module 17 in the direction of “Horizontal elongation input” which is designated as described above. The user can designate either of, for example, the left hand or the right hand as the hand by which the handwriting input pen 30 is to be held.

Here, “Right hand” 42 is designated as the hand by which the input pen 30 is to be held, by the finger 11 of the user.

FIG. 4C shows the state which is designated as described above, i.e., the state in which the direction of the electronic apparatus 10 in the case where the user performs a handwriting pen input is “Horizontal elongation” 41, and the user holds the input pen 30 by “Right hand” 42.

In the embodiment, in a part of the input module (image display module functioning also as a touch panel) 17, i.e., the input module (image display module functioning also as a touch panel) 17 at the position opposed to the holding portion 32 of the handwriting input pen 30, as shown in FIG. 4C, the touch operation non-detector 12 is disposed, and the input module is controlled so as not to detect a touch input.

According to the configuration, in the case where the user performs a pen input while holding the input pen 30 by “Right hand” 42, it is possible to set a mode where, even when “Right hand” touches the input module (image display module functioning also as a touch panel) 17, the touch is not detected.

In the embodiment, a touch input is enabled through the input module (image display module functioning also as a touch panel) 17 other than the touch operation non-detector 12.

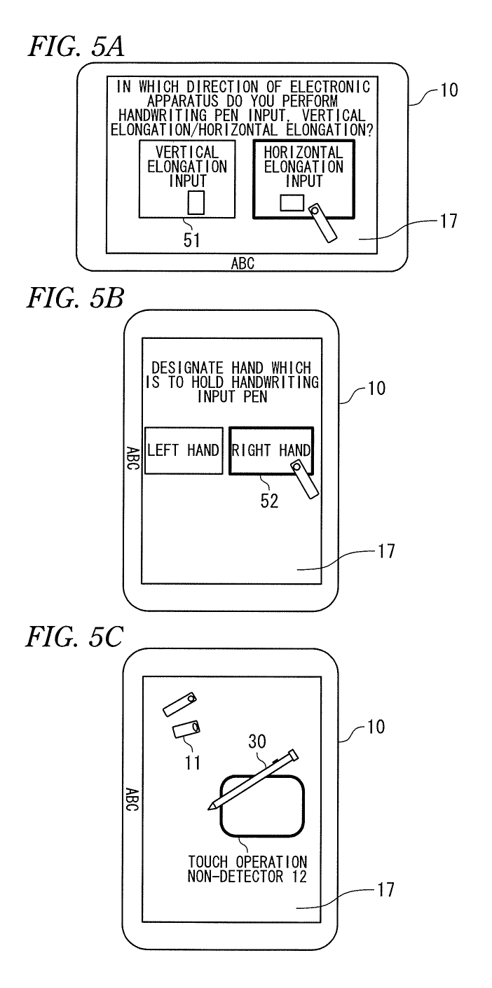

FIGS. 5A to 5C are views showing another example of the display screen on which, in the electronic apparatus of the embodiment, the user designates the direction of the electronic apparatus in the case where a handwriting pen input is performed, and the hand that is to hold the handwriting pen.

As shown in FIGS. 5A to 5C, an example of a display screen is shown on which, in a state where the electronic apparatus 10 is placed so as to be horizontally elongated with respect to the user, the user can designate the direction of the electronic apparatus in the case where a handwriting pen input is performed.

FIG. 5A shows an example of a display screen for designating the direction of the electronic apparatus 10 in which a handwriting pen input is performed.

Here, “In which direction of electronic apparatus do you perform handwriting pen input, vertical elongation/horizontal elongation?” is displayed on the image display module 17 functioning also as a touch panel so that the user can designate the direction of the electronic apparatus 10 in which a handwriting pen input is performed, for example, either of the vertically elongated direction or the horizontally elongated direction.

Here, “Vertical elongation” 51 is designated as the direction of the electronic apparatus 10 in which a handwriting pen input is performed, by the finger 11 of the user.

FIG. 5B shows an example of a display screen for designating the hand by which the user is to hold a handwriting input pen.

Here, “Designate hand which is to hold handwriting input pen” is displayed on the image display module 17 in the direction of “Vertical elongation input” which is designated as described above. The user can designate either of, for example, the left hand or the right hand as the hand by which the handwriting input pen 30 is to be held.

Here, “Right hand” 52 is designated as the hand by which the input pen 30 is to be held, by the finger 11 of the user.

FIG. 5C shows the state which is designated as described above, i.e., the state in which the direction of the electronic apparatus 10 in the case where the user performs a handwriting pen input is “Vertical elongation” 51, and the user holds the input pen 30 by “Right hand” 52.

Also in the embodiment, in a part of the input module (image display module functioning also as a touch panel) 17, i.e., the input module (image display module functioning also as a touch panel) 17 at the position opposed to the holding portion 32 of the handwriting input pen 30, as shown in FIG. 5C, the touch operation non-detector 12 is disposed, and the input module is controlled so as not to detect a touch input.

According to the configuration, in the case where the user performs a pen input while holding the input pen 30 by “Right hand” 52, it is possible to set a mode where, even when “Right hand” touches the input module (image display module functioning also as a touch panel) 17, the touch is not detected.

Also in the embodiment, a touch input is enabled through the input module (image display module functioning also as a touch panel) 17 other than the touch operation non-detector 12.

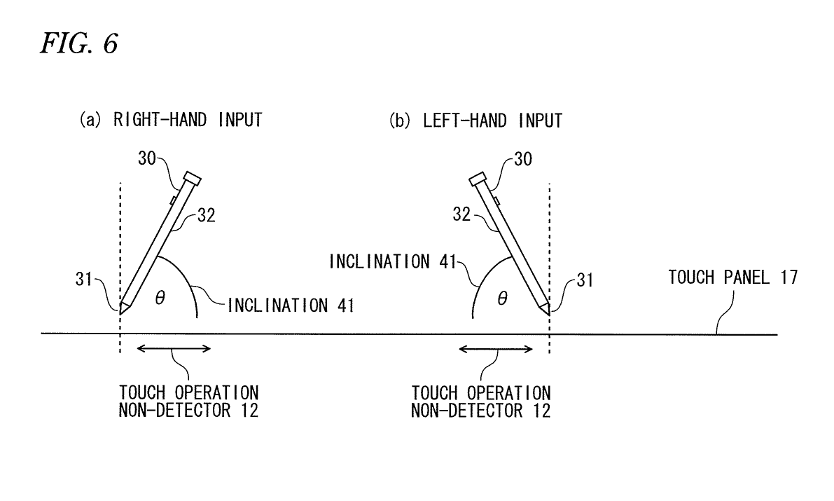

FIG. 6 is a diagram showing a manner in which, in the electronic apparatus of the embodiment, the handwriting pen that can perform a handwriting pen input detects the inclination in “Write” mode, and the electronic apparatus disposes a touch operation non-detector in a detector (touch panel) in accordance with the detected inclination of the pen.

As described above, for example, the position of the pen point portion 31 is detected by using the digitizer 17b of the touch panel 17.

In (a) of FIG. 6, the manner in which the user performs a pen input (write mode) while holding the handwriting input pen 30 by the right hand is shown.

Here, it is designated that the user holds the handwriting input pen 30 by the right hand as described above.

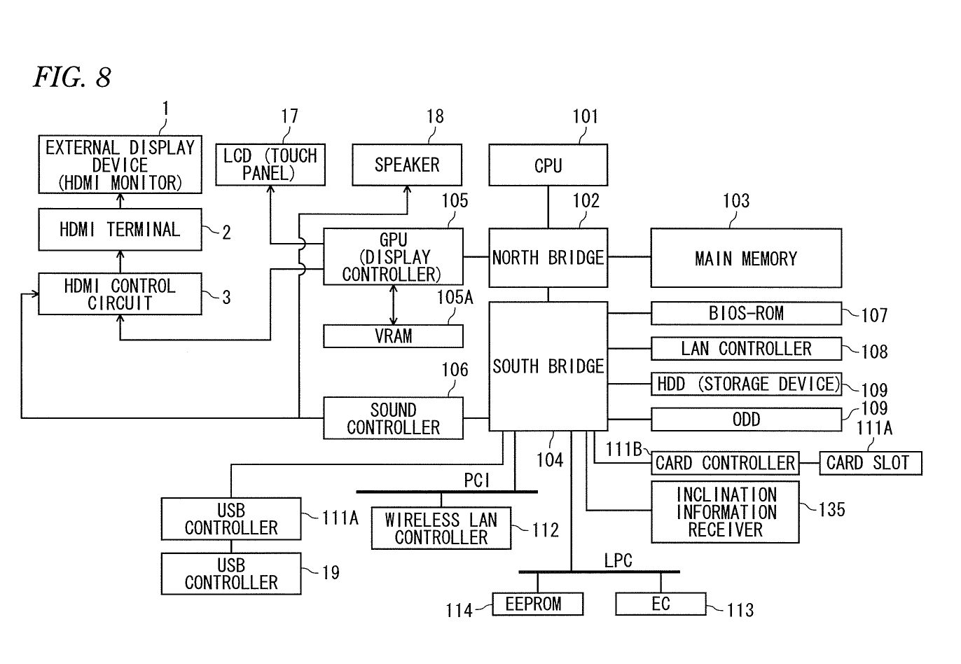

As shown in the figure, the inclination of the handwriting input pen 30 is detected by the inclination detector 34 which is configured in the handwriting input pen 30, and the inclination information is transmitted from the inclination information transmitting section 35 to an inclination information receiver 135 (FIG. 8) of the electronic apparatus 10.

In the case where the inclination has a predetermined value (for example, 10° or more and 85° or less), the touch operation non-detector 12 is disposed in the input module (touch panel) 17 at a position which is opposed to the holding portion 32 of the handwriting input pen 30 when the pen is held by the right hand.

In the case where the inclination does not have the predetermined value, the touch operation non-detector 12 may not be disposed.

In (b) of FIG. 6, the manner in which the user performs a pen input (write mode) while holding the handwriting input pen 30 by the left hand is shown.

Here, it is designated that the user holds the handwriting input pen 30 by the left hand.

As shown in the figure, the inclination of the handwriting input pen 30 is detected by the inclination detector 34 which is configured in the handwriting input pen 30, and the inclination information is transmitted from the inclination information transmitting section 35 to the inclination information receiver 135 (FIG. 8) of the electronic apparatus 10.

In the case where the inclination has a predetermined value (for example, 10° or more and 85° or less), the touch operation non-detector 12 is disposed in the input module (touch panel) 17 at a position which is opposed to the holding portion 32 of the handwriting input pen 30 when the pen is held by the left hand.

In the case where the inclination does not have the predetermined value, the touch operation non-detector 12 may not be disposed.

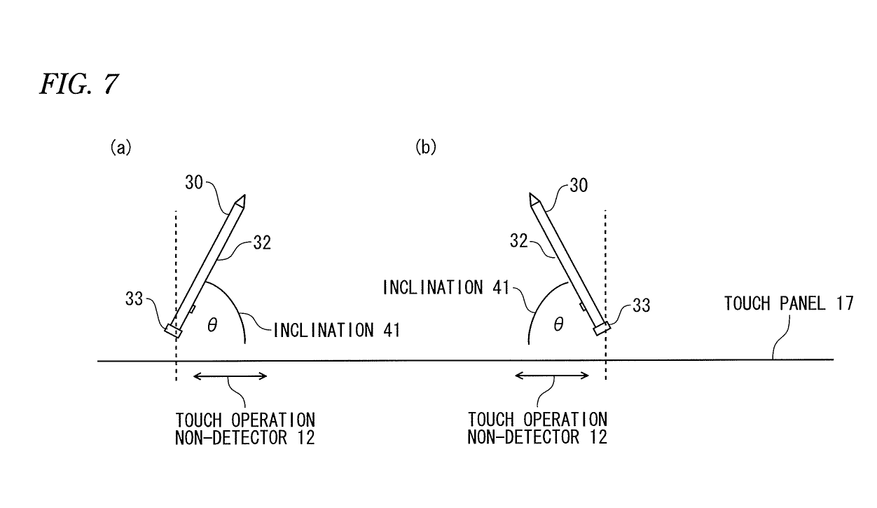

FIG. 7 is a diagram showing a manner in which, in the electronic apparatus of the embodiment, the handwriting pen that can perform a handwriting pen input detects the inclination in “Erasure” mode, and the electronic apparatus disposes the touch operation non-detector in the detector (touch panel) in accordance with the detected inclination of the pen.

As described above, for example, the position of the eraser function section 33 can be detected by using the digitizer 17b of the touch panel 17.

In (a) of FIG. 7, the manner in which the user performs a pen input (erasure mode) while holding the handwriting input pen 30 by the right hand is shown.

Here, it is designated that the user holds the handwriting input pen 30 by the right hand as described above.

As shown in the figure, the inclination of the handwriting input pen 30 is detected by the inclination detector 34 which is configured in the handwriting input pen 30, and the inclination information is transmitted from the inclination information transmitting section 35 to the inclination information receiver 135 (FIG. 8) of the electronic apparatus 10.

In the case where the inclination has a predetermined value (for example, 10° or more and 85° or less), the touch operation non-detector 12 is disposed in the input module (touch panel) 17 at a position which is opposed to the holding portion 32 of the handwriting input pen 30 when the pen is held by the right hand.

In the case where the inclination does not have the predetermined value, the touch operation non-detector 12 may not be disposed.

In (b) of FIG. 7, the manner in which the user performs a pen input (erasure mode) while holding the handwriting input pen 30 by the left hand is shown.

Here, it is designated that the user holds the handwriting input pen 30 by the left hand.

As shown in the figure, the inclination of the handwriting input pen 30 is detected by the inclination detector 34 which is configured in the handwriting input pen 30, and the inclination information is transmitted from the inclination information transmitting section 35 to the inclination information receiver 135 (FIG. 8) of the electronic apparatus 10.

In the case where the inclination has a predetermined value (for example, 10° or more and 85° or less), the touch operation non-detector 12 is disposed in the input module (touch panel) 17 at a position which is opposed to the holding portion 32 of the handwriting input pen 30 when the pen is held by the left hand.

In the case where the inclination does not have the predetermined value, the touch operation non-detector 12 may not be disposed.

FIG. 8 is a block diagram showing an example of the configuration of the electronic apparatus of the embodiment.

For example, at least a part of the configuration is accommodated as electronic components in the electronic apparatus (tablet PC) 10.

The electronic apparatus (tablet PC) 10 includes: a CPU (Central Processing Unit) 101; a north bridge 102; a main memory 103; a south bridge 104; a GPU (Graphics Processing Unit) 105; a VRAM (Video RAM (Random Access Memory)) 105A; a sound controller 106; a BIOS-ROM (Basic Input/Output System-Read Only Memory) 107; and a LAN (Local Area Network) controller 108.

The electronic apparatus further includes: a hard-disk drive (HDD (storage device)) 109; an optical disk drive (ODD) 110; a USB controller 111A; a card controller 111B; a wireless LAN controller 112; an embedded controller/keyboard controller (EC/KBC) 113; an EEPROM (Electrically Erasable Programmable ROM) 114; etc.

The CPU 101 is a processor which controls various portions of the electronic apparatus (tablet PC) 10.

The CPU 101 executes a BIOS stored in the BIOS-ROM 107. The BIOS is a program for controlling the hardware.

The north bridge 102 is a bridge device which connects between a local bus of the CPU 101 and the south bridge 104. The north bridge 102 incorporates a memory controller which controls an access to the main memory 103. For example, the north bridge 102 has also a function of communicating with the GPU 105 through a serial bus according to the PCI EXPRESS standard or the like.

The GPU 105 is a display controller which controls the video display module (LCD) 17 that is used as a display monitor of the electronic apparatus (tablet PC) 10.

A display signal produced by the GPU 105 is sent to the video display module (LCD) 17. The GPU 105 can transmit also a digital video signal to an external display device 1 through an HDMI (registered trademark) control circuit 3 and an HDMI (registered trademark) terminal 2.

The HDMI (registered trademark) terminal 2 is a terminal for connecting the above-described external display device. The HDMI terminal (registered trademark) 2 enables an uncompressed digital video signal and a digital audio signal to be transmitted through one cable to the external display device 1 such as a television receiver.

The HDMI (registered trademark) control circuit 3 is an interface for transmitting a digital video signal through the HDMI (registered trademark) terminal 2 to the external display device 1 that is called an HDMI (registered trademark) monitor.

The south bridge 104 controls devices on a PCI (Peripheral Component Interconnect) bus, and those on an LPC (Low Pin Count) bus. The south bridge 104 incorporates an IDE (Integrated Drive Electronics) controller for controlling the HDD 109 and the ODD 110.

The south bridge 104 has also a function of communicating with the sound controller 106.

The sound controller 106 is a sound source device, and outputs audio data to be reproduced to a speaker 18 or the HDMI (registered trademark) control circuit 3.

The LAN controller 108 is a wired communication device which executes wired communication according to, for example, the IEEE 802.3 standard. On the other hand, the wireless LAN controller 112 is a wireless communication device which executes wireless communication according to, for example, the IEEE 802.11g standard.

The USB controller 111A communicates with an external apparatus according to, for example, the USB 2.0 standard (connected through a USB connector 19).

For example, the USB controller 111A is used for receiving an image data file stored in a digital camera.

The card controller 111B executes writing/reading of data into/from a memory card such as an SD card inserted in a card slot disposed in the computer (note PC) main unit 11.

The EC 113 is an embedded controller for power management.

The EC 113 has a function of turning ON/OFF the power supply of the electronic apparatus (tablet PC) 10 in accordance with an operation of a power button 14 by the user.

In the embodiment, for example, the display control is performed when the CPU 101 executes programs stored in the main memory 103, the HDD 109, and the like.

For example, the electronic apparatus (tablet PC) 10 of the embodiment further includes the inclination information receiver which receives the inclination information of the handwriting input pen 30 that is transmitted from the inclination information transmitting section 35 disposed in the handwriting input pen 30.

The inclination information of the handwriting input pen 30 is detected inside the electronic apparatus 10, and a part of the input module (touch sensor 17a) at a position which is opposed to the holding portion 32 of the handwriting input pen 30 is controlled so as not to detect a touch input (the touch operation non-detector 12), by, for example, the CPU 101.

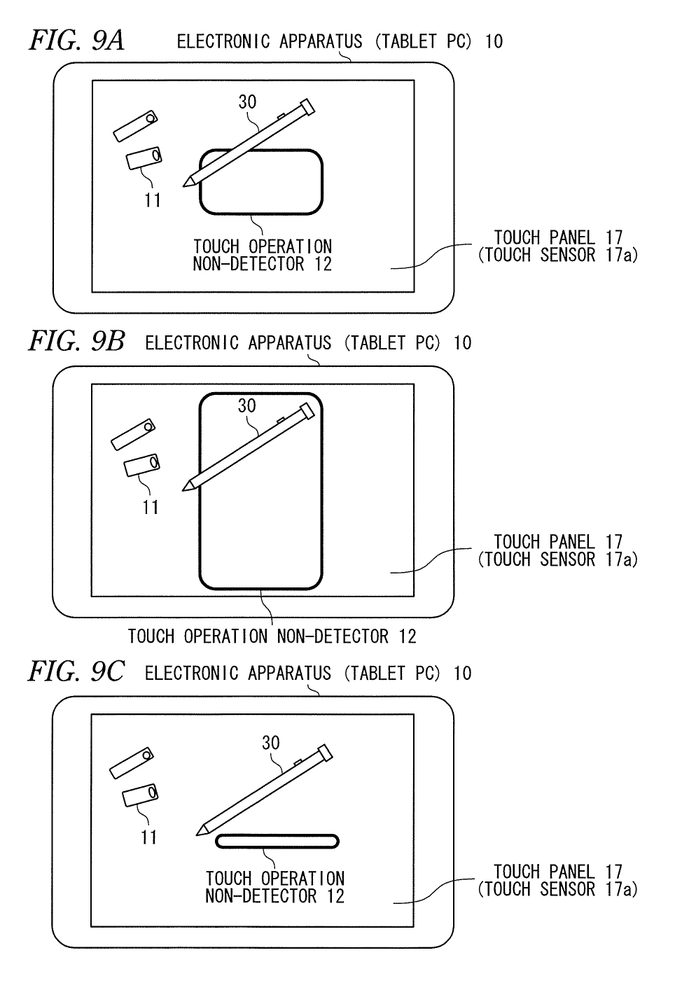

FIGS. 9A to 9C are views showing a manner in which, in the electronic apparatus of the embodiment, the handwriting pen that can perform a handwriting pen input detects the inclination in “Write” mode, and the electronic apparatus disposes the touch operation non-detector in the detector (touch panel) in accordance with the detected inclination of the pen.

FIG. 9A shows an example in which the size of the touch operation non-detector 12 disposed at a position that is opposed to the holding portion 32 of the handwriting input pen 30 is set in a range equivalent to that of the right hand of the user which holds the handwriting input pen 30.

According to the configuration, the touch panel 17 can sense a touch operation of the user, excluding the range which is at the position opposed to the holding portion 32 of the handwriting input pen 30, and which is equivalent to the size of the right hand.

FIG. 9B shows an example in which the size of the touch operation non-detector 12 is set in a range that is larger than that of the right hand of the user which holds the handwriting input pen 30.

According to the configuration, even when the user erroneously performs a touch operation in the vicinity of the position opposed to the holding portion 32 of the handwriting input pen 30, for example, the operation can be prevented from being detected.

FIG. 9c shows an example in which the size of the touch operation non-detector 12 is set in a range that is equivalent to that of the handwriting input pen 30.

According to the configuration, for example, the user can perform a touch operation on a wide range of the touch panel 17.

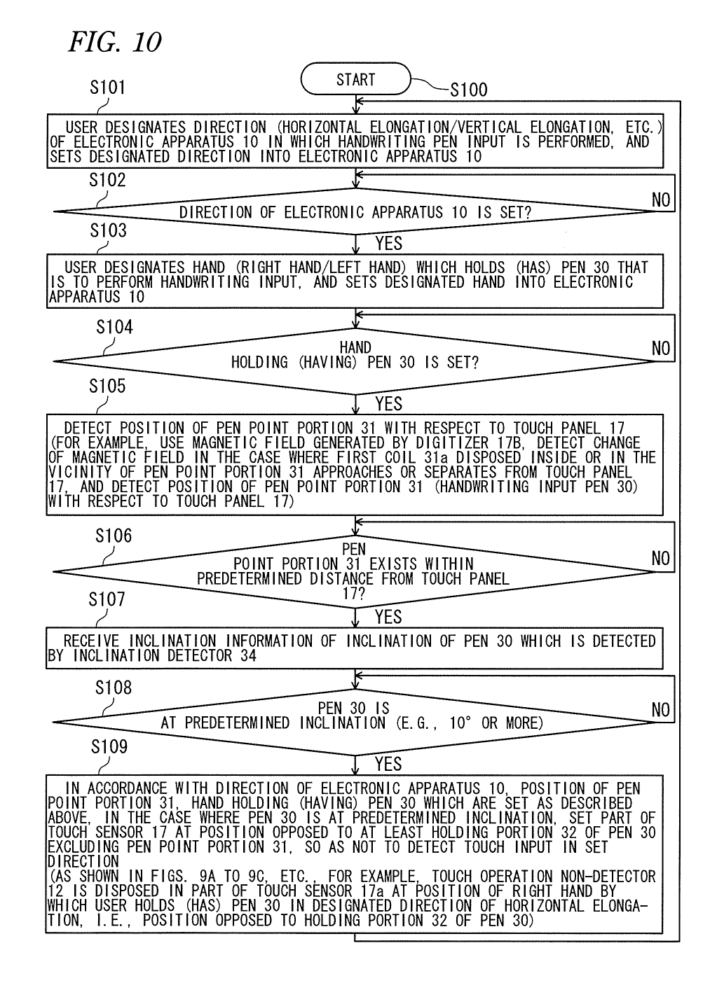

FIG. 10 is a flowchart illustrating the operation of “Write” mode in the electronic apparatus of the embodiment.

As described above, for example, the handwriting input pen 30 and the pen point portion 31 are used in “Write” mode in which a handwriting input is performed.

Step S100 is the starting step of the flow, and then the process proceeds to step S101.

Step S101 is a step where the user designates the direction (horizontal elongation/vertical elongation and the like) of the electronic apparatus 10 in which a handwriting pen input is performed, and sets the designated direction into the electronic apparatus 10. Then, the process proceeds to step S102.

Step S102 is a step of detecting whether the direction of the electronic apparatus 10 is set or not. If it is detected that the direction of the electronic apparatus 10 is set, the process proceeds to step S103 (Yes). If it is detected that the direction of the electronic apparatus 10 is not set, the process in this step is repeated (No).

Step S103 is a step where the user designates the hand (right hand/left hand) which holds (has) the pen 30 that is to perform a handwriting input, and sets the designated hand into the electronic apparatus 10. Then, the process proceeds to step S104.

Step S104 is a step of detecting whether the hand holding (having) the pen 30 is set or not. If it is detected that the hand holding (having) the pen 30 is set, the process proceeds to step S105 (Yes). If it is not detected that the hand holding (having) the pen 30 is set, the process in this step is repeated (No).

Step S105 is a step of detecting the position of the pen point portion 31 with respect to the touch panel 17.

The detection of the position of the pen point portion 31 with respect to the touch panel 17 can be realized in the following manner. For example, the magnetic field generated by the digitizer 17b is used, a change of the magnetic field in the case where the first coil 31a disposed inside or in the vicinity of the pen point portion approaches or separates from the touch panel 17 is detected, and the position of the pen point portion 31 (handwriting input pen 30) with respect to the touch panel 17 is detected. Then, the process proceeds to step S106.

Step S106 is a step of detecting whether the pen point portion 31 exists within a predetermined distance (for example, about 1 cm to about 5 cm) from the touch panel 17 or not. If it is detected that the pen point portion 31 exists within the predetermined distance from the touch panel 17, the process proceeds to step S107 (Yes). If it is not detected that the pen point portion 31 exists within the predetermined distance from the touch panel 17, the process in this step is repeated (No).

Step S107 is a step of receiving the information (inclination information) of the inclination of the pen 30 which is detected by the inclination detector 34. Then, the process proceeds to step S108.

Step S108 is a step of detecting whether the pen 30 is at a predetermined inclination angle of, for example, 10° or more or not. If it is detected that the pen 30 is at the predetermined inclination, the process proceeds to step S109 (Yes). If it is not detected that the pen 30 is at the predetermined inclination, the process in this step is repeated (No).

In step S109, the following operation is performed in accordance with the direction of the electronic apparatus 10, position of the pen point portion 31, hand holding (having) the pen 30, and the like which are set as described above. In the case where the pen 30 is at the predetermined inclination, a part of the touch sensor (input module) 17 at a position opposed to at least the holding portion 32 of the pen 30 excluding the pen point portion 31 is set so as not to detect a touch input in the set direction.

In the embodiment, as shown in FIGS. 9A to 9C, and the like, for example, the touch operation non-detector 12 is disposed in a part of the touch sensor 17a at the position of the right hand by which the user holds (has) the pen 30 in the set direction of horizontal elongation, i.e., the position opposed to the holding portion 32 of the pen 30. Then, the process proceeds to step S101 to repeat the above-described process.

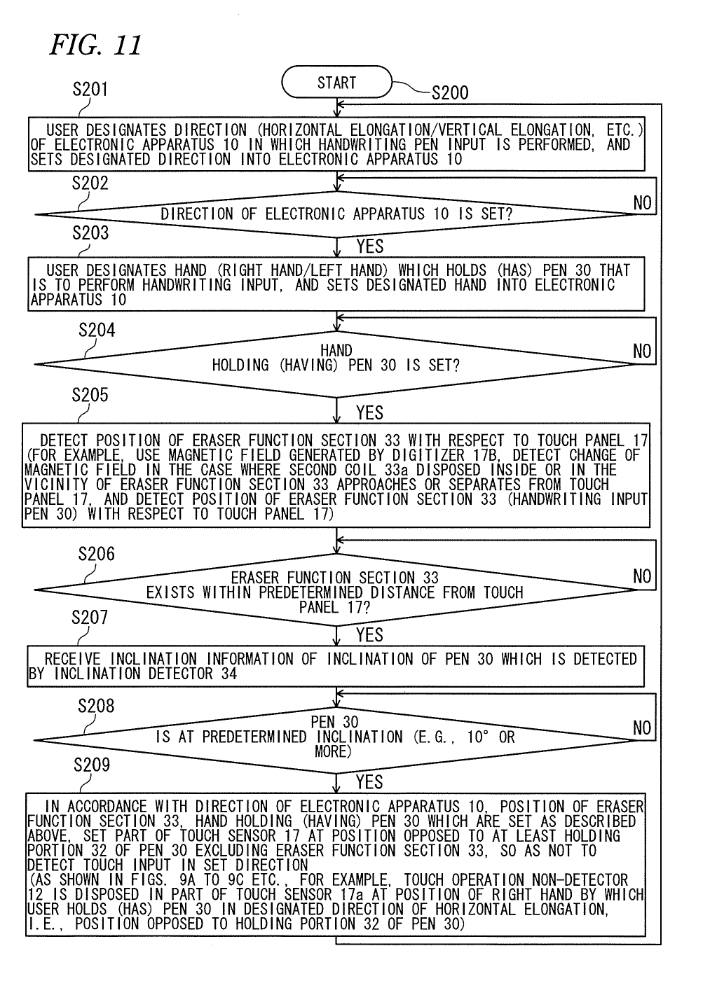

FIG. 11 is a flowchart illustrating the operation of “Erasure” mode in the electronic apparatus of the embodiment.

As described above, for example, the handwriting input pen 30 and the eraser function section 33 are used in “Erasure” mode in which a handwriting input is performed.

Step S200 is the starting step, and then the process proceeds to step S201.

Step S201 is a step where the user designates the direction (horizontal elongation/vertical elongation and the like) of the electronic apparatus 10 in which a handwriting pen input is performed, and sets the designated direction into the electronic apparatus 10. Then, the process proceeds to step S202.

Step S202 is a step of detecting whether the direction of the electronic apparatus 10 is set or not. If it is detected that the direction of the electronic apparatus 10 is set, the process proceeds to step S203 (Yes). If it is not detected that the direction of the electronic apparatus 10 is set, the process in this step is repeated (No).

Step S203 is a step where the user designates the hand (right hand/left hand) which holds (has) the pen 30 that is to perform a handwriting input, and sets the designated hand into the electronic apparatus 10. Then, the process proceeds to step S204.

Step S204 is a step of detecting whether the hand holding (having) the pen 30 is set or not. If it is detected that the hand holding (having) the pen 30 is set, the process proceeds to step S205 (Yes). If it is not detected that the hand holding (having) the pen 30 is set, the process in this step is repeated (No).

Step S205 is a step of detecting the position of the eraser function section 33 with respect to the touch panel 17.

In the embodiment, for example, the magnetic field generated by the digitizer 17b is used, a change of the magnetic field in the case where the second coil 33a disposed inside or in the vicinity of the eraser function section 33 approaches or separates from the touch panel 17 is detected, and the position of the eraser function section 33 (handwriting input pen 30) with respect to the touch panel 17 is detected. Then, the process proceeds to step S206.

Step S206 is a step of detecting whether the eraser function section 33 exists within a predetermined distance (about several cm) from the touch panel 17 or not. If it is detected that the eraser function section 33 exists within the predetermined distance from the touch panel 17, the process proceeds to step S207 (Yes). If it is not detected that the eraser function section 33 exists within the predetermined distance from the touch panel 17, the process in this step is repeated (No).

Step S207 is a step of receiving the inclination information of the pen 30 which is detected by the inclination detector 34. Then, the process proceeds to step S208.

Step S208 is a step of detecting whether the pen 30 is at a predetermined inclination angle of, for example, 10° or more or not. If it is detected that the pen 30 is at the predetermined inclination, the process proceeds to step S209 (Yes). If it is not detected that the pen 30 is at the predetermined inclination, the process in this step is repeated (No).

In step S209, in accordance with the direction of the electronic apparatus 10, position of the eraser function section 33, hand holding (having) the pen 30, and the like which are set as described above, a part of the touch sensor 17 at a position opposed to at least the holding portion 32 of the pen 30 excluding the eraser function section 33 is set so as not to detect a touch input in the set direction.

In the embodiment, as shown in FIGS. 9A to 9C, and the like, for example, the touch operation non-detector 12 is disposed in a part of the touch sensor 17a at the position of the right hand by which the user holds (has) the pen 30 in the designated direction of horizontal elongation, i.e., the position opposed to the holding portion 32 of the pen 30.

Then, the process proceeds to step S201 to repeat the above-described process.

As described above, the electronic apparatus 10 of the embodiment can simultaneously perform a touch input and a handwriting pen input by a handwriting pen on the touch panel (input module) 17 functioning also as an image display module.

The electronic apparatus includes a hold designation module in which a hand that is to hold the handwriting pen is designated (for example, FIGS. 4B and 5B).

The electronic apparatus includes a pen point portion detector (for example, the digitizer 17b) which detects the position of the pen point portion 31 of the handwriting input pen 30 with respect to the input module.

The electronic apparatus includes a controller (the CPU 101 and the like) which controls a part of the input module (touch panel) 17 at a position opposed to a holding portion 32 of the handwriting input pen 30, so as not to detect the touch input (the touch operation non-detector 12) in accordance with the detected position of the pen point portion 31 and the designated hand holding the handwriting input pen 30.

The electronic apparatus 10 of the embodiment includes a direction designation module (for example, FIGS. 4A and 5A) in which the direction of the electronic apparatus 10 on which a pen input by the handwriting input pen 30 is to be performed is designated. In accordance with the designated direction of the electronic apparatus 10, a part of the input module (touch panel) 17 is controlled so as not to detect the touch input (the touch operation non-detector 12).

The electronic apparatus 10 of the embodiment includes the inclination information receiver 135 which can receive the inclination information of the handwriting input pen 30. In the case where the handwriting input pen 30 is at the predetermined inclination, a part of the input module (touch panel) 17 is controlled so as not to detect the touch input (the touch operation non-detector 12).

The electronic apparatus 10 of the embodiment includes: the direction designation module (for example, FIGS. 4A and 5A) in which the direction of the electronic apparatus 10 on which a pen input by the handwriting input pen 30 is to be performed is designated; and the inclination information receiver 135 which can receive the inclination information of the handwriting input pen 30. In accordance with the designated direction of the electronic apparatus 10, in the case where the handwriting input pen 30 is at the predetermined inclination, a part of the input module (touch panel) 17 is controlled so as not to detect the touch input (the touch operation non-detector 12).

The electronic apparatus 10 of the embodiment includes: the display module (FIGS. 4B and 5B) which can display the display of the hold designation module; and the display module (FIGS. 4A and 5A) which can display the display of the direction designation module.

The electronic apparatus 10 of the embodiment can simultaneously perform a touch input and a pen input by the handwriting input pen on the input module 17 formed in the touch panel.

The electronic apparatus 10 includes the hold designation module (FIGS. 4B and 5B) in which a hand that is to hold the handwriting pen 30 is designated.

The electronic apparatus includes an eraser function section detector (digitizer 17b) which detects the position of the eraser function section 33 of the handwriting input pen 30 with respect to the input module (touch panel) 17.

The electronic apparatus includes a controller (CPU 101) which controls a part of the input module (touch panel) 17 at a position opposed to the holding portion 32 of the handwriting input pen 30, so as not to detect the touch input (the touch operation non-detector 12) in accordance with the detected position of the eraser function section 33 and the designated hand holding the handwriting input pen 30.

In the embodiment, namely, the inclination detector (gyro sensor and the like) 34 is mounted on the handwriting input pen (touch pen) 30, the inclinations of the pen point portion 31 of the handwriting input pen (touch pen) 30, and the handwriting input pen (touch pen) 30 are used, and the input disabled region (touch operation non-detector 12) is disposed in a part of the input module (touch panel) 17 for a touch operation, thereby preventing an erroneous touch operation from being performed in the input disabled region (touch operation non-detector 12).

According to the configuration, in the embodiment, it is possible to provide an electronic apparatus in which a touch input and a handwriting pen input can be easily simultaneously performed, and the convenience is improved.

All the procedure of the control process in the embodiment can be executed by software. Therefore, the same effects as those of the embodiment can be easily achieved simply by installing and executing programs for executing the procedure of the control process in a usual computer through a computer-readable recording medium storing the programs.

The embodiment is not limited to the description as it is, and, in the stage of implementation, the invention can be embodied while the components are variously modified without departing the spirit of the invention.

By appropriate combinations of plural components disclosed in the embodiment, various inventions can be configured.

For example, some of the components may be omitted from all of the components shown in the embodiment. Moreover, the components in different embodiments may be appropriately combined.

What is claimed is:

1. An electronic apparatus comprising:
an input module formed in a touch panel in which a touch input and a pen input by a handwriting pen are performed on;
a hold designation module in which a hand that is to hold the handwriting pen is designated;
a pen point portion detector configured to detect a position of a pen point portion of the handwriting input pen with respect to the input module; and
a controller configured to control a part of the input module at a position opposed to a holding portion of the handwriting pen so as not to detect the touch input in accordance with the detected position of the pen point portion and the designated hand that is to hold the handwriting input pen.

2. The electronic apparatus according to claim 1, further comprising
a direction designation module in which a direction of the electronic apparatus, on which a pen input by the handwriting input pen is to be performed, is designated, wherein
a part of the input module is controlled so as not to detect the touch input in accordance with the designated direction of the electronic apparatus.

3. The electronic apparatus according to claim 1, further comprising
an inclination information receiver configured to receive inclination information of the handwriting input pen, wherein
a part of the input module is controlled so as not to detect the touch input in a case that the handwriting input pen is at a predetermined inclination.

4. The electronic apparatus according to claim 1, further comprising
a direction designation module in which a direction of the electronic apparatus, on which a pen input by the handwriting input pen is to be performed, is designated; and
an inclination information receiver configured to receive inclination information of the handwriting input pen, wherein
a part of the input module is controlled so as not to detect the touch input in accordance with the designated direction of the electronic apparatus in a case that the handwriting input pen is at a predetermined inclination.

5. The electronic apparatus according to claim 1, further comprising
a display module configured to display a display of the hold designation module.

6. The electronic apparatus according to claim 2, further comprising
a display module configured to display a display of the direction designation module.

7. An electronic apparatus comprising:
an input module formed in a touch panel in which a touch input and a pen input by a handwriting pen are simultaneously performed on;
a hold designation module in which a hand that is to hold the handwriting pen is designated;
an detector configured to detect a position of an eraser function section of the handwriting input pen with respect to the input module; and
a controller configured to control a part of the input module at a position opposed to a holding portion of the handwriting pen so as not to detect the touch input in accordance with the detected position of the eraser function section and the designated hand that is to hold the handwriting input pen.

8. A method of controlling an electronic apparatus in which a touch input and a pen input by a handwriting pen are performed on an input module formed in a touch panel, the method comprising:
designating a hand that is to hold the handwriting pen;
detecting a position of a pen point portion of the handwriting input pen with respect to the input module; and
controlling a part of the input module at a position opposed to a holding portion of the handwriting pen so as not to detect the touch input in accordance with the detected position of the pen point portion and the designated hand that is to hold the handwriting input pen.

9. A recording medium for a program for controlling an electronic apparatus in which a touch input and a pen input by a handwriting pen are performed on an input module formed in a touch panel, wherein the program includes:
designating a hand that is to hold the handwriting pen;
detecting a position of a pen point portion of the handwriting input pen with respect to the input module; and
controlling a part of the input module at a position opposed to a holding portion of the handwriting pen, so as not to detect the touch input, in accordance with the detected position of the pen point portion and the designated hand that is to hold the handwriting input pen.
